(19) United States
(12) Patent Application Publication
(10) Pub. No.: US 2009/0204499 A1
(43) Pub. Date: Aug. 13, 2009

(54) ELECTRONIC INCENTIVE DISTRIBUTION SYSTEM

(76) Inventor: Ty Joseph Caswell, Zimmerman, MN (US)

Correspondence Address: MERCHANT & GOULD PC, P.O. BOX 2903, MINNEAPOLIS, MN, 55402-0903, US

(21) Appl. No.: 12/368,874

(22) Filed: Feb. 10, 2009

Related U.S. Application Data
(60) Provisional application No. 61/028,355, filed on Feb. 13, 2008.

(51) Int. Cl. G06Q 30/00; G06Q 20/00

(52) U.S. Cl. 705/14; 705/21; 705/20

(57) ABSTRACT

Product incentive distribution systems and methods are disclosed. One such system includes a product incentive distribution unit placed at a retail location in association with a product and configured to electronically receive product incentives. The product incentive distribution unit includes a display configured to display product information and product incentive information and a communication port configured to transmit product incentive information to a data communications device. The system also includes a handheld data communications device having a communication port configured to receive product incentive information and a memory configured to collect product incentive information. The system also includes a checkout system including a communications interface communicatively connectable to the data communications device, the checkout system configured to receive product incentive information from the handheld data communications device and apply the product incentive information to one or more products purchased by a user.

### CROSS-REFERENCE TO RELATED APPLICATIONS

The present application claims priority to U.S. Provisional Patent Application No. 61/028,355, filed Feb. 13, 2008, the disclosure of which is hereby incorporated by reference in its entirety.

### TECHNICAL FIELD

The present disclosure relates generally to sales of goods at retail stores. More specifically, the present disclosure relates to an electronic incentive distribution system.

### BACKGROUND OF THE INVENTION

Manufacturers of products sold in large volumes, such as food and other dispensable household goods, often promote these products by printing advertisements including coupons relating to those products. These coupons and advertisements are typically sent to potential customers who may choose to use those coupons to receive discounts on the items in any of a variety of supermarkets or other retailers.

When a customer chooses to use one of these manufacturer-issued coupons, that customer selects and brings those coupons to a store of the customer's choice. The customer purchases the goods that correspond to the coupons, and receives a cash discount relating to the final purchase price of the goods from the retailer. The retailer then receives reimbursement from the manufacturer based on the number of coupons that were issued by the manufacturer and used/honored by the retailer.

Retailers may also choose to print and distribute coupons related to the products and services that they have in stock. In these situations, the customer again selects the appropriate coupons, and brings them to the retailer's place of business. When the customer purchases items relating to the coupons, that customer again receives a cash discount on the final price of the goods.

The current systems of coupon delivery have a number of disadvantages. For example, there is a large delay in the time from which a manufacturer or a retailer issues a coupon until the time it is used. Also, a small fraction of coupons that are printed are in fact used, and those coupons must be physically brought to the retailer location for use. Furthermore, use of the manufacturer coupons does not generate any retailer loyalty, although retailer-issued coupons generally are product (and manufacturer) specific.

For these and other reasons, improvements are desirable.

### SUMMARY OF THE INVENTION

In accordance with the present disclosure, the above and other problems are solved by the following:

In a first aspect, a product incentive distribution system is disclosed. The product incentive distribution system includes a product incentive distribution unit placed at a retail location in association with a product and configured to electronically receive product incentives. The product incentive distribution unit includes a display configured to display product information and product incentive information and a communication port configured to transmit product incentive information to a data communications device. The system also includes a handheld data communications device having a communication port configured to receive product incentive information and a memory configured to collect product incentive information. The system also includes a checkout system including a communications interface communicatively connectable to the data communications device, the checkout system configured to receive product incentive information from the handheld data communications device and apply the product incentive information to one or more products purchased by a user.

In a second aspect, a method of distributing product incentives to in-store customers is disclosed. The method includes distributing a product incentive distribution unit in association with a product at a retail location, and receiving a product incentive at the product incentive distribution unit, the product incentive being transmitted from a source of the product. The method also includes displaying information relating to the product incentive on a display of the product incentive distribution unit and transmitting the product incentive to a handheld data communications device associated with a customer. The method further includes processing the product incentive by a checkout system.

In a third aspect, a product incentive distribution system is disclosed. The system includes a product incentive distribution unit placed in association with a product. The product incentive distribution unit includes a display configured to display product information and product incentive information, and a communication port configured to communicate with a data communications device. The system also includes a handheld data communications device. The data communications device includes a communication port configured to communicate with the product incentive distribution unit and a memory configured to store information related to the product incentive distribution system, the information including a device identifier. The system further includes a checkout system configured to process a retail transaction with a customer associated with the handheld data communications device and receive product incentive information and apply the product incentive information to one or more products purchased by the customer. The system also includes a retailer inventory server configured to electronically receive product incentive information from a source of a product and associate the handheld data communications device with one or more of the product incentives based on the device identifier, the device identifier received from the product incentive distribution unit.

In a fourth aspect, a method of distributing product incentives to in-store customers is disclosed. The method includes distributing a product incentive distribution unit in association with a product at a retail location, and receiving a product incentive at a retail inventory server, the product incentive being transmitted from a source of the product. The method further includes displaying information relating to the product incentive on a display of the product incentive distribution unit, obtaining an identifier of a handheld data communications device associated with a customer at the product incentive distribution unit, and transmitting the identifier to the retail inventory server for association with the product incentive. The method also includes processing the product incentive by a checkout system.

### BRIEF DESCRIPTION OF THE DRAWINGS

FIG. 1 illustrates a communication network used along a supply chain of goods, useable to implement aspects of the present disclosure;

FIG. 2 illustrates a retailer network for distributing product incentives, according to a possible embodiment of the present disclosure;

FIG. 3 shows a perspective schematic view of a product display shelf utilizing a product incentive distribution system, according to a possible embodiment of the present disclosure;

FIG. 4 shows a perspective schematic view of a product display hanger utilizing a product incentive distribution system, according to a possible embodiment of the present disclosure;

FIGS. 5A-5D illustrate communications between personal communications devices and various aspects of a product incentive distribution system, according to a possible embodiment of the present disclosure;

FIG. 6A-6B illustrate various communications networks useable by aspects of the product incentive distribution system;

FIG. 7 shows a schematic front plan view of a data communications device according to a possible embodiment of the present disclosure;

FIG. 8 shows a schematic front plan view of the data communications device of FIG. 7 with a protective cover removed;

FIG. 9 shows a schematic side plan view of the data communications device of FIG. 7;

FIG. 10 shows a schematic view of a data communications device, according to a further possible embodiment of the present disclosure

FIG. 11 is an exemplary schematic of the circuitry of a data communications device according to a possible embodiment of the present disclosure;

FIG. 12 is an exemplary schematic of the circuitry of a product incentive distribution device according to a possible embodiment of the present disclosure;

FIG. 13 is an exemplary schematic view of circuitry included within a data communications device, according to a possible embodiment of the present disclosure;

FIG. 14 is an exemplary schematic view of circuitry included within a data communications device, according to a further possible embodiment of the present disclosure;

FIG. 15 is an exemplary schematic view of circuitry included within a data communications device, according to a further possible embodiment of the present disclosure;

FIG. 16 shows an exemplary data packet containing product data communicated using the methods and systems described herein;

FIG. 17 shows a further exemplary data packet containing product data communicated using the methods and systems described herein;

FIG. 18 shows a further exemplary data packet containing device-identifying data communicated using the methods and systems described herein;

FIG. 19 illustrates a flowchart of methods and systems for distributing product incentives, according to a possible embodiment of the present disclosure;

FIG. 20 illustrates a flowchart of methods and systems for distributing product incentives, according to a possible embodiment of the present disclosure; and

FIG. 21 illustrates a flowchart of methods and systems for use of product incentives, according to a possible embodiment of the present disclosure.

### DETAILED DESCRIPTION

Various embodiments of the present disclosure will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many embodiments possible.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

In general, the present disclosure relates to methods and systems for distribution of product incentives, such as coupons, that are distributed by a manufacturer or retailer of a variety of types of goods. The methods and systems described herein generally provide a process by which customers can receive incentives to purchase goods at a retail location, such as a supermarket or other retailer, without requiring use of paper coupons in the retail store. The process uses data communications devices that can communicate with product incentive distribution unit, so as to, for example, receive information relating to goods associated with the unit. A customer can select products for purchase and can collect corresponding product incentives through a communicative connection between the various product incentive distribution units associated with the products and that customer's data communications device. When the customer checks out and elects to pay for the items, that customer receives a discount or other incentive on the items selected by communicating the collected product incentives at a checkout counter, from the device or a server connected to the checkout system at the counter. The methods and systems of the present disclosure provide a process by which product incentives can be distributed in-store to customers on an on-demand basis, eliminating printing costs and allowing the product incentives to be applied immediately or upon a subsequent trip to the retailer.

Using the systems and methods of the present disclosure, the product incentives that are associated with products at a retailer can be provided for use of a customer by the retailer itself, or by a manufacturer or other entity within the supply chain of that product leading to the retailer. In this context, any of these entities is referred to as a source of the product with respect to the customer.

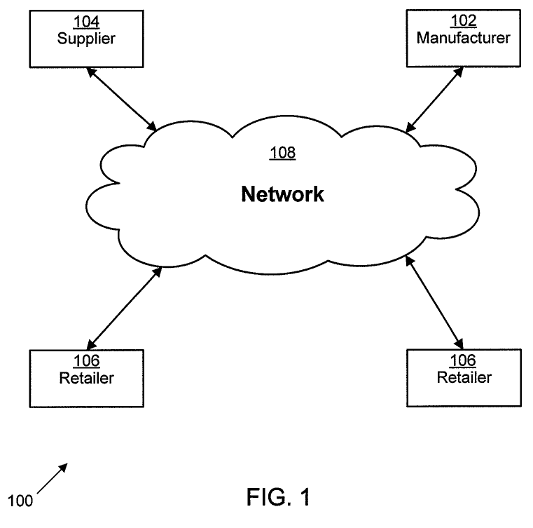

Referring now to FIG. 1, a communication network 100 is shown which can be used by entities positioned along a supply chain of goods. The communication network 100 is generally intended to illustrate data communications among a variety of entities, including sources such as manufacturers 102, suppliers 104, and retailers 106. The manufacturers 102 generally produce goods that are to be sold to retailers 106, and may optionally have one or more suppliers 104 transmitting those goods from the manufacturer to the retailer. In general, retailers can include supermarkets, wholesalers, “big box” retailers, or other sellers of goods. Suppliers 104 can include various resellers or importers of goods. Suppliers 104 can also include various manufacturers or assemblers of systems. In this sense, a supplier is considered to be the entire group of entities manufacturing and distributing goods to retailers along a supply chain to the retailer. Each of these entities can interconnect to share data relating to product placement, supply chain issues, and product incentives using a network 108, which can be, in various embodiments, the Internet or some similar network.

The network 100 is intended to illustrate data sharing among the various entities. In such a network 100, a manufacturer 102 or supplier 104 can transmit information to a retailer 106 related to one or more products provided by the manufacturer or supplier and sold by the retailer. This information can include supply inventories, as well as details about the product, including the price charged to the retailer, the suggested retail price, size and details of the product, bar code or other identifying information, and any coupons or other incentives that may be applied to the product. Additionally, using the network 100, a retailer 106 can communicate to the manufacturer 102 and/or supplier 104, requesting, for example, additional information, additional products to be delivered, different products to be delivered.

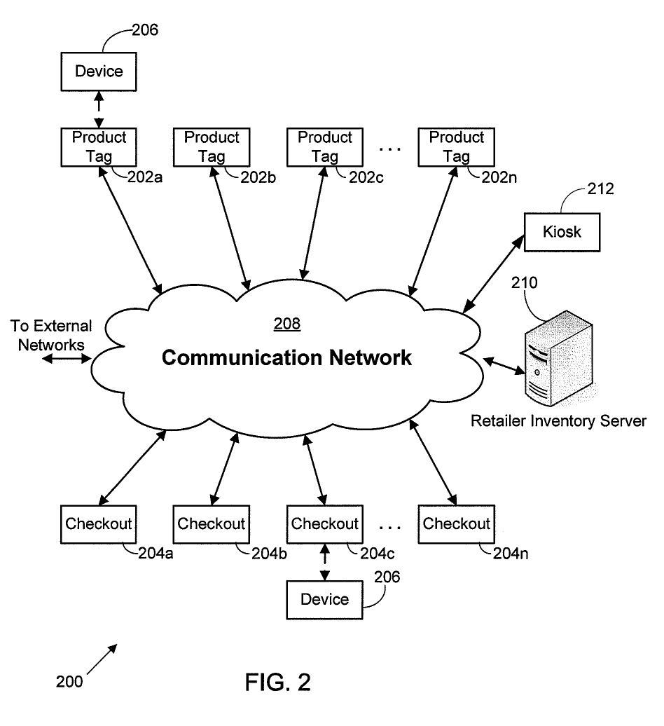

FIG. 2 illustrates a retailer network 200 for distributing product incentives, according to a possible embodiment of the present disclosure. The retailer network 200 can, in certain embodiments, be a network present at one or more retail locations controlled by a retailer, such as one of the retailers 106 shown in FIG. 1. The retailer network 200 includes a plurality of product incentive dispensing units 202a-n, a plurality of checkout systems 204a-n, and a plurality of data communications devices 206. The product incentive dispensing units 202a-n and checkout systems 204a-n communicatively connect to a network 208, which can be a local area network within a retail store location (or locations), or other type of network.

The product incentive dispensing units 202a-n are generally associated with products, and are arranged to distribute product incentives related to the product with which the units are associated. The product incentive dispensing units 202a-n can, for example, be placed or mounted on or near a display of a product, and can display information related to a product incentive. In a possible example, the product incentive dispensing units 202a-n electronically dispense product incentives relating to the product with which the unit is associated, such as to the data communications devices 206, described in further detail below.

The product incentive dispensing units 202a-n communicatively connect to the network 208 via any of a variety of wired or wireless data communication connections, such as by 802.11 or other radio frequency (RF) standards, or wired via network cabling, USB cabling, or other standard communication cable systems. In further embodiments, cellular communications systems are incorporated into the product incentive dispensing units 202a-n for long-range communication with systems, such as computing systems of manufacturers or suppliers, as recited in conjunction with FIG. 1. In certain embodiments, the product incentive dispensing units 202a-n are powered by the same cable as that which provides the communication connection; in other embodiments, a power cable or internal power system (e.g. a battery) is employed.

The plurality of checkout systems 204a-n correspond generally to electronic cash registers or other payment systems in use by a retailer to receive payment from customers in exchange for the goods purchased. The checkout systems 204a-n communicate with the data communications devices 206, as further described below, to receive collected product incentive messages from the data communications devices and to apply those incentives to the products currently being purchased by the consumer.

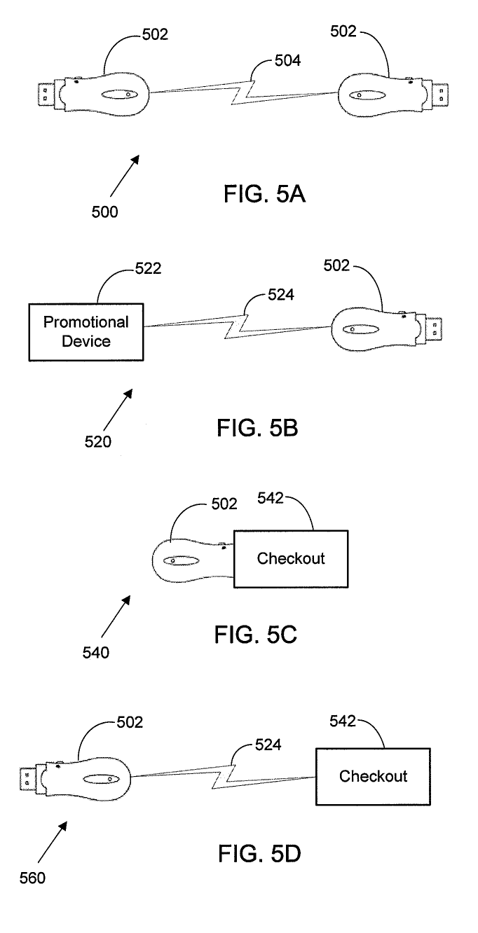

The data communications devices 206 are communicatively connectable to both the product incentive dispensing units 202a-n and the checkout systems 204a, but are portable around a location implementing the network 200 to enable a communication connection to any of the various units and systems. The data communications devices are generally portable memory devices having a data communications interface by which they can communicate at short range with the various product incentive dispensing units 202a-n to receive the product incentive relating to the product with which each particular unit is associated. For example, if a product incentive dispensing unit displays a possible discount coupon relating to a good (e.g. milk, a bottle of water, a toothbrush, clothing, etc.), a customer holding a data communications device 206 can obtain the product incentive (e.g. coupon) associated with that product, if the customer chooses to purchase the product. The data communications device 206 receives incentive data and stores it in a memory of the device, such that it can be processed at one of the various checkout systems 204a-n of the retailer. Example data communications devices are described below in conjunction with FIGS. 5-10.

A retail inventory server 210 can also optionally be included in the network 200, and can manage and track inventory associated with a retailer or retail location. The retail inventory server 210 can be, in various embodiments, a generalized computing system having a database resident thereon, and at any time will contain an inventory listing of the types and volume of products received by, sold by, and held at the retailer. The retail inventory server 210 can receive messages from a supplier or manufacturer, such as messages relating to product incentives. The retail server can distribute these product incentive messages within the network 200 to the various product incentive dispensing units 202a-n for display and distribution to customers, as explained in further detail below. In further embodiments, messages received from a supplier or manufacturer can be directly distributed to the product incentive dispensing units 202a-n without routing by such a server.

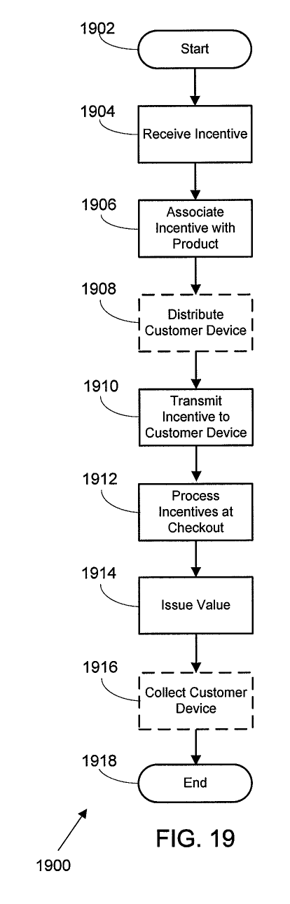

In certain embodiments, the retail inventory server 210 also receives data from the product incentive dispensing units 202a-n, such as customer identifying or device identifying data, related to which data communications device 206 communicatively connects to which product incentive dispensing unit. By tracking this information at the retail inventory server 210, the retail inventory server can assess product incentives associated with that specific data communications device, and apply associated product incentives without requiring that those product incentives are transmitted to the device during use by a customer during a shopping trip. Additional details regarding usage of the various aspects of the network are described below in FIGS. 19-21, as well.

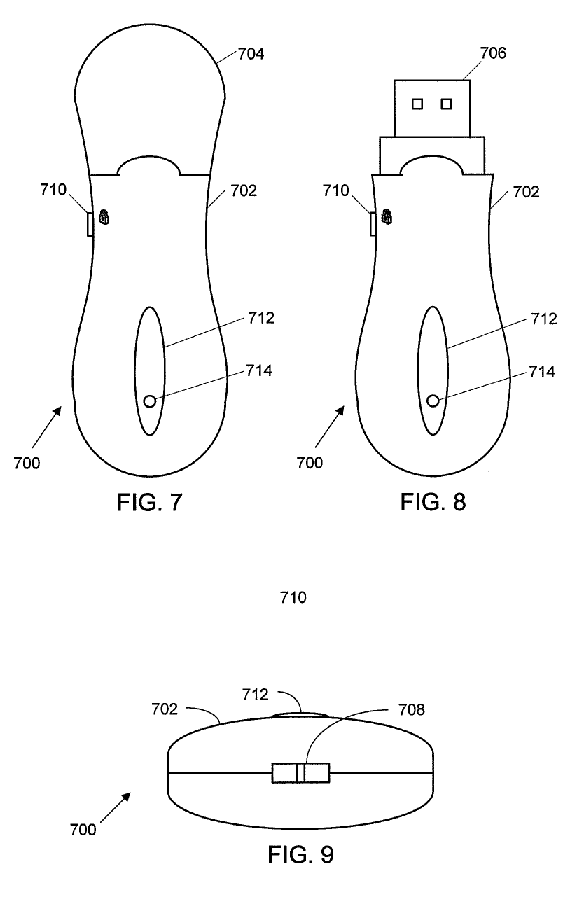

A kiosk 212 can be located at the retail location within the network 200 for distributing data communications devices to customers visiting the location. In certain embodiments, the kiosk can be a vending machine configured to distribute devices for a nominal fee (or with no fee), and those devices can be reused each time the customer returns to the retail location. In some other embodiments, the kiosk can be configured to program the devices with user-identifying or device-identifying information, and transmit that information to the retail inventory server 210 for storage by the retailer (e.g. to collect customer and demographic information of the customer requesting a data communications device). The kiosk can further be configured to link a bar code printed on a device (e.g. any of the devices of FIGS. 7-10) with the device identifier, to allow a checkout system to access incentives associated with the device identifier by scanning such a bar code.

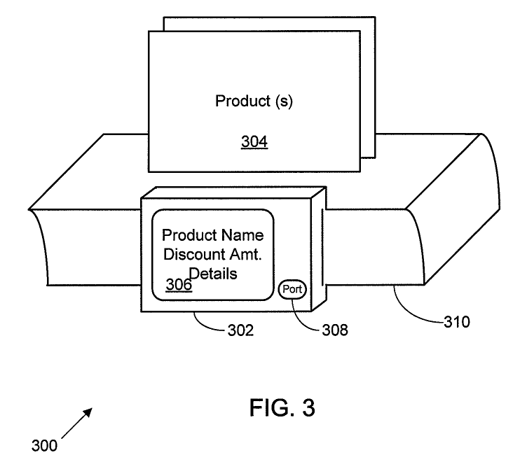

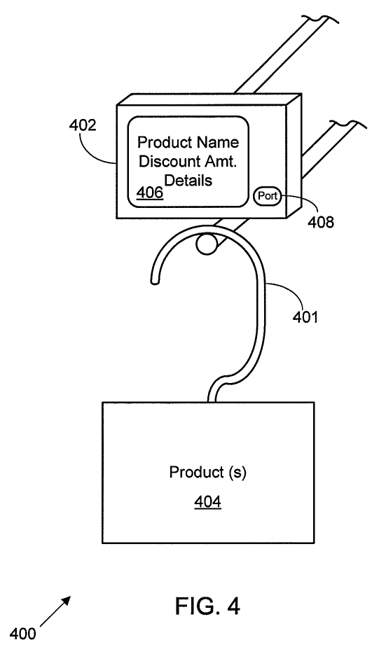

FIGS. 3-4 show perspective schematic views of example product displays incorporating a product incentive distribution system, according to various embodiments of the present disclosure. FIG. 3 relates to a product display shelf arrangement 300 utilizing a product incentive distribution system. As shown, the shelf arrangement 300 includes a product incentive dispensing unit 302 attached to a front edge of a shelf 310, in close proximity to one or more products 304 placed on the shelf. As such, the product incentive dispensing unit 302 is “associated” with the product, in that the unit dispenses incentives related to the product.

In the embodiment shown, the product incentive dispensing unit 302 includes a display 306 and a communication port 308. The display 306 can be, in various embodiments, a liquid crystal display, such as a color display or a bichromatic seven segment display, or other types of low-power, low cost displays. The display 306 can, in certain embodiments, display a variety of product information to the customer, such as information generally placed in a tag attached to the store shelf. This information can include, for example, the name of the product, price, volume, and other identifying information. The information can also include additional incentive information regarding any incentives which may be available to the user through use of the unit 302, such as coupons, temporary price reductions, or other information. The communication port 308 can be, for example, any wireless or wired communication system capable of data communication with a portable handheld memory device, such as the data communications devices described in FIGS. 5-16, below.

In certain embodiments, the port 308 is an infrared or RF port capable of wireless data transfer of product incentives to such a data communications device. In further embodiments, the port 308 includes a photodiode arranged and configured to receive and translate modulated laser signals from a data communications device. Other arrangements are possible as well.

The product incentive dispensing unit 302 is mounted to a front portion of a shelf 310 in front of the product 304. The product 304 and shelf 310 can be arranged in various configurations, such that the product incentive dispensing unit 302 is clearly visually associated with the product or product Stock Keeping Unit (SKU).

In general, the product incentive dispensing unit 302 includes a wired or wireless connection enabling connection to and incorporation within an overall retailer network, such as the network 200 of FIG. 2. In various embodiments, the product incentive dispensing unit 302 can include a power receipt system or battery enabling that unit to power the display 306 and/or port 308. In certain of these embodiments, the power receipt system or battery is electrically integrated or recharged by the wired connection to the unit.

FIG. 4 shows a perspective schematic view of a product display hanger arrangement 400 utilizing a product incentive distribution system, according to a possible embodiment of the present disclosure. The product display hanger arrangement 400 generally corresponds to the display shelf arrangement 300 of FIG. 3, but can be used in instances where the product is received onto a hanger 401, as shown.

The product display hanger includes a product incentive dispensing unit 402. The product incentive dispensing unit 402 generally corresponds to the unit 302 of FIG. 3, but is configured to be mountable to a hanger tag location above a hanger display for one or more products 404. In other arrangements, the product incentive dispensing unit 402 is mountable to a hanger tag location below a hanger display of one or more products 404. The unit 402 includes a display 406 and a port 408, which generally correspond to the analogous features of FIG. 3, described above.

FIGS. 5A-5D illustrate communications between personal communications devices and various aspects of a product incentive distribution system, according to a possible embodiment of the present disclosure. FIG. 5A shows a communication network 500 that can be formed between various data communications devices 502 which may be used within the retailer network 200 of FIG. 2. The devices 502 are communicatively connectable via a communication link 504, which can be, in various embodiments, a wired or wireless electrical or optical connection at a port of the device, as described in FIGS. 7-9 or 10.

FIG. 5B illustrates a communications link 520 that can be formed between a data communications device 502 and a promotional device 522, according to a possible embodiment of the present disclosure. The promotional device 522 can be, for example, a product incentive dispensing unit such as the units described above in FIGS. 2-4 and FIG. 11, below. In the link configuration 520 shown, the data communications device 502 forms a communicative connection 524 to the promotional device 522 by ports on each of those devices. The communicative connection 524 can be a wired, wireless, electrical, magnetic, or optical communication configuration, according to various embodiments.

FIG. 5C illustrates a communications link 540 that can be formed between a data communications device 502 and a checkout system 542, according to a possible embodiment of the present disclosure. In various embodiments, the checkout system 542 can correspond to any of the checkout systems 204a-n of FIG. 2.

Although in the embodiment shown the communications link 540 shows the data communications device 502 connected to the checkout system 542 via a USB interface, it is understood that the data communications device 502 can connect to the checkout system using any of a number of communication links, such as the wired or wireless connections previously described as used to communicate product incentives among the data communications devices and product incentive dispensing units.

FIG. 5D illustrates a communications link 560 that can be formed between a data communications device 502 and a checkout system 542 according to a further possible embodiment of the present disclosure. In this embodiment, the data communications device connects to the checkout system via a communications link 520.

As previously described, the communications link can be an audible communications link, an optical communications link, a radio frequency communications link, a direct wired communications link, or other types of communications links. Furthermore, in various embodiments, the communications link can be a one-way or two-way communications link, as further described below.

Alternatively to FIG. 5C or 5D, the communication between the checkout system 542 and data communications device 502 can operate to identify the data communications device, such as by scanning an identifier printed on the data communications device. Such identifiers can, in various embodiments, include bar codes, numeric codes, RFID chips or other types of device identifiers.

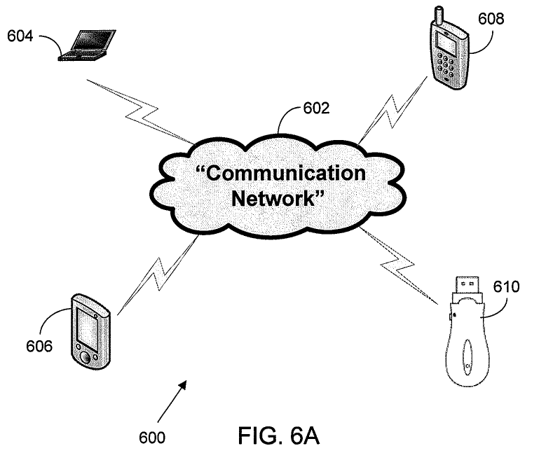

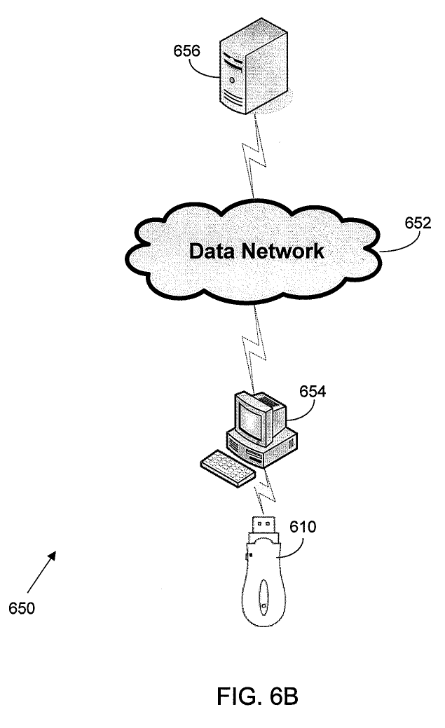

FIG. 6A-6B illustrate various communications networks useable by aspects of the product incentive distribution system. FIG. 6A shows an exemplary communications network 600 in which aspects of the present disclosure can be implemented. The communications network 600 is intended to illustrate the point made above; namely, that various types of devices can communicate using any of a variety of types of communication links, or a mixture thereof. One example of such a link is an at least partially audible sound network. The network 600 includes a communication link 602 interconnecting a variety of devices, such as a personal computer 604, a personal digital assistant 606, a cellular telephone 608, or a handheld memory device 610. Additional devices are possible as well. In various embodiments, the communication link is a standard of communication allowing communication by various wired or wireless media, such as a sound wave communication link, infrared communication link, wireless (RF) communication link, or wired communication link.

Any of the devices 604-610 can communicate with any of the other devices over the communication link 602. Further, when one device transmits information the remaining devices can all sense that information when placed within range that those other devices can audibly, electrically, optically, or otherwise detect the sound emitted from the first device.

FIG. 6B shows a further exemplary communications network 650 in which aspects of the present disclosure can be implemented. The communications network 650 is arranged to illustrate a method of accessing files for which pointers are passed among data communications devices. The communications network 650 uses a standard internet connection 652 connecting a personal computing system 654 with a server system 656 to access files referenced on a data communications device, such as a USB flash drive. The communications network 650 includes a data communications device 610, such as those shown in FIGS. 7-10 below. The handheld memory device is electrically connected to a personal computing system 654, such as through a USB port. In this embodiment, the handheld memory device 610 can store files and can also store reference identifiers to specific media files. By using such an embodiment of the system, the various handheld memory devices described herein can transmit either files or can transmit pointers to those files that are stored remotely, such as on a server system 656. When the pointer is transmitted between two devices, a user of the device to which the pointer is transmitted can then access the data by connecting the handheld memory device 610 to a computing system (e.g. computing system 654) and accessing the file stored on the server 656 by reference to the pointer stored on the device.

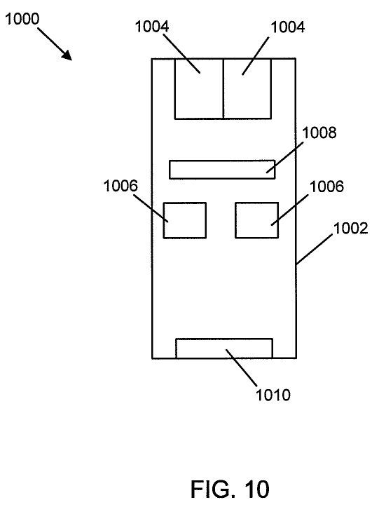

FIGS. 7-9 show a data communications device 700 according to one possible embodiment of the present disclosure. The data communications device 700 is one example of a handheld device in which the systems of FIGS. 1-2 can be implemented. The device 700 incorporates one or more of various audible, electrical, and optical data transmission/receipt features with data storage and transmission features, as described below and in conjunction with FIG. 10.

The data communications device 700 includes a housing 702 configured to fit in the hand of a user. The housing 702 can be manufactured from any of a variety of substantially rigid materials, such as plastic or metal. The housing 702 is contoured to fit the hand of a user, with a narrow center portion and flared ends.

The housing includes a cover 704 at a top end of the housing to protect an electrical interface 706, seen in FIG. 8. In the embodiment shown, the electrical interface 706 is a Universal Serial Bus (USB) interface configured to be plugged into a USB port for data and power transfer between the device 700 and other computing equipment, such as a personal computer. The electrical interface 706 can be configured to interface with a nonvolatile memory residing within the interior of the housing 702, such as a flash memory or miniaturized hard drive configured for data storage. Additional circuitry can be included within the housing as well, and can be externally connected to other electronic/computing equipment via the electrical interface 706.

In a possible embodiment, the electrical interface has a top edge that is curved to be outwardly convex (shown as a flat edge in FIG. 7), which may be considered more ergonomically pleasing if required to be held near the ear of an individual using the device 700. Other shapes are possible as well.

A port 708 at the base end of the housing 702 allows sound, light or radio waves to enter and exit the housing 702 of the device 700. The port 708 optionally includes two openings. In the case that the port is used for audible communication, one of the openings can be configured to transmit audible sounds and one can be configured to receive audible sounds. In the case that the port is used for infrared or other optical transmissions, one opening or optical connection can be used for an LED or other optical transmitter, while another opening can be related to a photodetector or other optical receiver. Other configurations of the port are possible as well, generally relating to the method/medium of transmission of data.

Additionally, a second port can be integrated into the electrical interface 706 at the top end of the device 700, such that the send and/or receive functions produce audible sounds emitted from the portion of the device 700 including the electrical interface 706. In one embodiment, both the send and receive functions are located at the end of the device 700 including the electrical interface 706. In a second embodiment, one of the send and/or receive functions occurs at the electrical interface 706 and the complementary function occurs at the port 708. In a further embodiment, both functions occur at both locations.

A lock switch 710 located along a side edge of the housing 702 allows a user to selectively lock the device 700 such that one or more functions of the device 700 is deactivated. In one embodiment, the lock switch 710 deactivates the electrical interface 706, preventing data communication with external computing devices. In a further embodiment, the lock switch 710 deactivates at least one of the send and/or receive functions of the device 700, such that various extraneous sounds are not perceived by the device to be data transmission. Combinations of these functions, or multiple lock switches, are possible as well.

An activation button 712 located along a front face of the housing 702 activates data transmission via an audible signal. A user, by depressing and optionally holding down the activation button, activates a method of sending and/or receiving data, such as product incentives distributed in a product incentive distribution system managed by a supplier or retailer of goods. An indicator 714 embedded within the activation button 712 indicates to the user when digital data has been successfully sent or received.

FIG. 10 illustrates a further possible embodiment of a data communications device 1000, according to a possible embodiment of the present disclosure. In certain embodiments, the data communications device 1000 is a low-cost, handheld computing device, such as a USB flash drive sized device. In one embodiment, the data communications device 1000 includes a body section 1002, a plurality of communication apertures 1004, a plurality of actuable switches or buttons 1006, a first surface 1008, and a first aperture 1010. In certain embodiments, the body section 1002 is a molded plastic form having a plurality of ergonomic features to facilitate attendee handling. In general, body section 1002 serves to contain a plurality of functional electronic circuitry within an enclosed internal section (not shown).

In certain embodiments, the communication apertures 1004 are defined as a wireless communication port and a USB port. In a preferred embodiment, the wireless communication port is an infrared communications port. However, other types of wireless communications ports can be used as well. For example, the wireless communication port can be, in various embodiments, an audible communication port, a radio frequency communication port, or other wireless communication port capable of communicating via other protocols/media. Further, in general, the USB port can be any type of USB port. For example, the USB can be a Standard-A connection, a Standard-B connection, a Mini-B connection or other types of USB connections.

In certain embodiments, the plurality of actuable switches 1006 can for example include an on/off switch, a mode switch, a download request switch, and/or others. In one embodiment, switches 1006 can be any type of binary switch such as a rocker switch, a pushbutton, and/or any combination of other types of switches such as dials and the like. For example, in one possible embodiment the data communications device 1000 can be configured operate in a mode that requires a command, such as depressing a respective switch 1006, to exchange information with or transmit information to a compatibly configured computing device. Alternatively, the data communications device 1000 can be configured to operate in a mode that functions as a “listening mode” by depressing a respective switch 1006 such that the data communications device 1000 periodically “sniffs” for a communications signal. Other arrangements are possible as well.

As described above, in certain embodiments the body section 1002 can include a first surface 1008 and an aperture 1010. In one embodiment, the first surface 1008 is an ink friendly signature line for labeling with a writing utensil such as a pen or a marker. Further, in certain embodiments aperture 1010 can be formed such that a lanyard can be inserted therethrough. In this manner, the data communications device 1000 can be easily secured and/or transported as desired.

Additional embodiments of data communications devices are shown and described in U.S. patent application Ser. No. 12/024,349, and U.S. patent application Ser. No. 12/251,251, both entitled “Personal Information Communication Device and Method”, the disclosures of both of which are hereby incorporated by reference in their entireties.

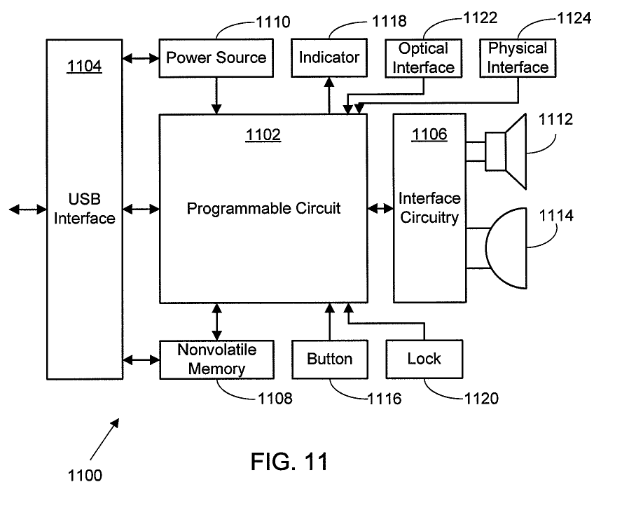

FIG. 11 shows an exemplary schematic of circuitry 1100 of a data communications device according to a possible embodiment of the present disclosure. The circuitry 1100 can be implemented, for example, in the device 700 shown in FIGS. 7-9 or the other devices disclosed in U.S. patent application Ser. No. 12/024,349, and U.S. patent application Ser. No. 12/251,251, which were previously incorporated by reference. Alternately, the circuitry can be implemented in a cellular telephone, personal digital assistant, or other handheld or portable electronics.

The circuitry, in general includes a programmable circuit 1102, and an electrical interface 1104, an acoustic interface 1106, a memory 1108, and a power source 1110. The circuitry can also include an optical interface 1122 and a physical interface 1124 as well, or as a replacement for the acoustic interface 1106.

The programmable circuit 1102 controls overall operation of the data communications device in which it is located. The programmable circuit includes a digital signal processor configured to perform the analog to digital and digital to analog conversions necessary to convert the digital data packets for transmission via one of the various interfaces.

The programmable circuit 1102 also optionally includes additional operational logic configured to access memory, and to respond to the various interfaces to the programmable circuit. In one embodiment, the programmable circuit 1102 includes a microcontroller. The microcontroller can be programmable in any of a number of programming languages, such as assembly language, C, or other low-level language. In alternate embodiments, the programmable circuit 1102 includes a programmable logic device (PLD) such as a field programmable gate array (FPGA), Complex Programmable Logic Device (CPLD), or Power ASIC (Application Specific Integrated Circuit). In these embodiments, a hardware description language such as Verilog, ABEL, or VHDL defines operation of the programmable circuit 1102.

The electrical interface 1104 provides an electrical and data connection between the circuitry 1100 and connecting circuitry of an external or additional computing device. In the embodiment shown, the electrical interface 1104 is a USB interface, which allows the system to both (1) transmit and receive data along the interface, and (2) receive electrical power, such as to power the system or charge a power source (i.e., a battery) included in the circuitry 1100.

The acoustic interface 1106 includes various circuit elements that may be necessary, depending upon the chosen implementation of the programmable circuit, to convert the analog signals received from the programmable circuit 1102 and to convert those signals to audible sounds, and vice versa. The acoustic interface includes a transducer 1112 configured to output sounds based on analog signals received from the programmable circuit 1102, and a receiver, such as a receiver 1114, configured to receive sounds and convert those sounds to analog electrical signals recognizable to the electrical circuit. In various possible embodiments, the frequency response of the transducer 1112 allows performance at one or more frequencies, such as from about 200 Hz to about 3400 Hz of standard POTS phone lines, or within the audible bandwidth of a cellular telephone transmission.

The transducer 1112 and receiver 1114 can be arranged in a number of ways to reduce interference between them and prevent sound feedback in the circuitry 1100. In one possible embodiment, the transducer 1112 is located remotely from the receiver 1114, such as at opposite ends of a device in which they are located. In a further possible embodiment, a system incorporating these components may have dedicated ports for each of the transducer 1112 and receiver 1114. In yet a further possible embodiment, the transducer 1112 and receiver 1114 are arranged concentrically to minimize feedback. In such a configuration, the transducer 1112 may be formed in a logarithmic acoustic shape. The receiver 1114 can be directly coupled to a transducer 1112 and formed in a complementary shape to receive directionally oriented sound emitted from a transducer 1112 in a complementary audible data communications device. One or more of these configurations may be used in any one device incorporating the acoustic interface 1106.

The memory 1108 can be any of a variety of preferably non-volatile, electrically erasable and reprogrammable memories. In a possible embodiment, the memory 1108 is a flash memory. Other memory technologies are integrable into the circuitry 1100 as well. The memory generally stores instructions for operation of the data communications device, and can also be configured to have sufficient unused memory locations to collect and accumulate product incentives received from product incentive distribution units, according to the present disclosure. In embodiments in which the device does not receive product incentives, less memory is required, in that only a device identifier will remain stored on the device.

The power source 1110 provides electrical power to the circuitry 1100 when the circuitry is not connected to an external power source via the electrical interface 1104. In a possible embodiment, the power source 1110 is a compact, rechargeable battery. The power source can preferably be recharged using the electrical interface as well. However, in a further embodiment, the power source 1110 is replaceable.

The circuitry 1100 also includes an activation button 1116, an indicator 1118, and a lock switch 1120. The activation button 1116 allows a user to activate one or more functions incorporated into the circuitry 1100. In one embodiment, the activation button activates the programmable circuit 1102 and acoustic interface 1106 to cause data stored in the memory 1108 to be transmitted audibly via the transducer 1112. In a further embodiment, the activation button also activates the acoustic interface 1106 to allow receipt of audible sounds at the receiver 1114 and conversion to digital data. In other embodiments, the activation button activates communication via one or more alternative communication interfaces (e.g. the optical interface 1122, below).

The indicator 1118 provides a visible indication to a user of the status of the device in which the circuitry 1100 is embodied. The indicator can be configured to be activated upon successful audible receipt and/or transmission of the digital data. The indicator can also be configured to indicate when the power source 1110 needs to be replaced, or can indicate a state corresponding to when the electrical interface 1104 is connected to an external electronic device (such as when the circuitry is connected via the USB connection to recharge the power source 1110).

The lock switch 1120 locks one or more of the functions of the circuitry so as to prevent unintentional data transmission/receipt. In one embodiment, the lock switch 1120 activates and deactivates the receiver 1114 or one or more components of the acoustic interface 1106, preventing translation of one or more unintentional sounds to digital data, which would result in storage of extraneous data within the memory 1108. In a further embodiment, the lock switch 1120 activates and deactivates both the receiver 1114 and the transducer 1112, preventing both transmission and receipt of audible data. In still other embodiments, the lock switch 1120 prevents reading from or writing to the memory 1108, or transmission of data along the electrical interface 1104. Combinations of these functions may be implemented with the lock switch 1120 as well.

The optical interface 1122 provides an alternate method by which data can be communicated between data communications devices and among the various other systems in the product incentive distribution systems of the present disclosure. The optical interface 1122 is configured to send and receive data analogously to the acoustic interface 1106. The optical interface 1122 can be used as a selectable alternative to the acoustic interface 1106 for implementations in which audible sounds are not desired, or can replace that interface altogether for use in a port of a data communications device, such as are shown in FIGS. 7-10. In one embodiment, the optical interface 1122 includes an infrared transmitter/receiver. In such an embodiment, the optical interface 1122 transmits and receives data in all or part of the useable bandwidth provided by the selected infrared transmitter/receiver.

In a further possible embodiment, the optical interface 1122 includes a laser diode for transmitting data to a product incentive distribution unit based on modulation of the signal using a square wave to apply coded data to the laser diode signal. In such an embodiment, the optical interface 1122 can also include a photodiode for receiving analogous optical signals.

In certain embodiments, the optical interface 1122 can be used in conjunction with the acoustic interface 1106 to transmit data at a higher data rate. In still further embodiments, the optical interface 1122 can completely replace the acoustic interface 1106 and the transmitter 1112 and receiver 1114 in data communications.

The optional physical interface 1124 provides a further alternate method by which data can be communicated between data communications devices. The physical interface 1124 is configured to send and receive data analogously to the acoustic interface 1106 and the optical interface. The physical interface can be used as a further selectable alternative to the other interfaces, such as where the other interfaces are non-operable. In such embodiments, the physical interface can correspond to electrical circuitry and electrical contacts capable of forming a digital or analog data connection between two like devices.

In a possible embodiment, the circuitry 1100, and the electrical interface 1104 in particular, can be used to program the programmable circuit 1102 or to place information into memory 1108 regarding the type and/or size of data to be transmitted (as well as the data itself). In such an embodiment, software may be provided to a user that can be used to access and define the various fields of the data packets or, in general, the data to be transferred.

In a further possible embodiment, the circuitry 1100 is configured such that, upon connection to an external computing device, such as a product incentive distribution system, via the electrical interface 1104, data is imported into the memory 1108, such as product advertisements, coupons, or other messages.

In yet another possible embodiment, the circuitry 1100 is configured such that, upon connection to an external computing device via the electrical interface 1104, data is exported from memory 1108 such that the information held within the memory 1108 is duplicated onto a computing device, such as a personal computer, for further use and distribution.

Using the systems disclosed herein, such as the circuitry 1100 implementing methods such as those shown in FIGS. 1-2, it is preferable that the duration of communication between two or more devices be of a limited duration so as to maximize the convenience of the methods and systems for data transfer. It is further preferable that robust communications protocols be used (particularly in the case of use for audible data transfer) due to possible signal noise and other interfering effects.

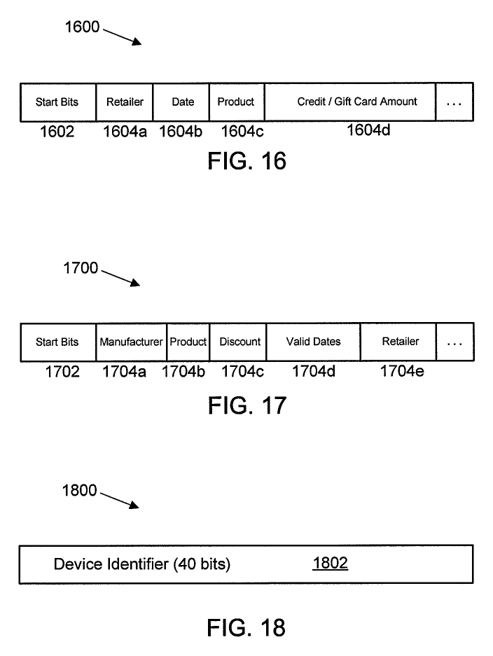

In one possible embodiment, the circuitry operates to transmit data at a 1200 bit per second rate, which is a widely available international data transmission standard. Using this transmission rate allows the systems described herein to transmit a kilobyte in roughly 6-7 seconds (including header information and any of various handshaking algorithms required), and allowing a 300 byte file to be transmitted in about two seconds or less. In certain embodiments, about 150 bytes of data are typically transferred at a time, allowing for about a single second of data transfer. Larger or smaller files used to maintain the product incentive information require a proportional amount of time for data transmission. To allow larger files to be transferred in a shorter time, higher data transmission speeds can be implemented, such as 2400 bps, 4800 bps, 9600 bps, or the like, using full or half duplex modes of operation. Typical file or incentive sizes are sufficiently small to allow simple, robust transmission of data, as illustrated in FIGS. 16-17, below.

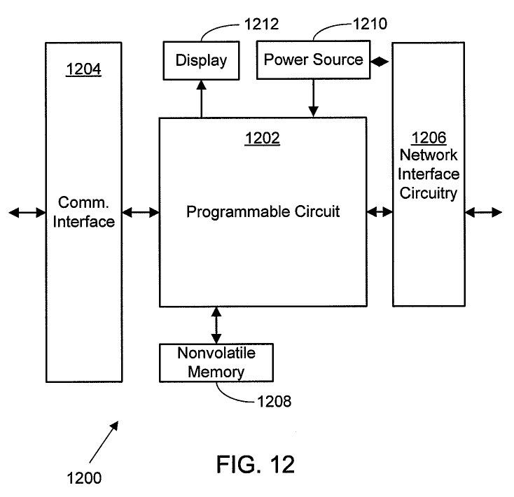

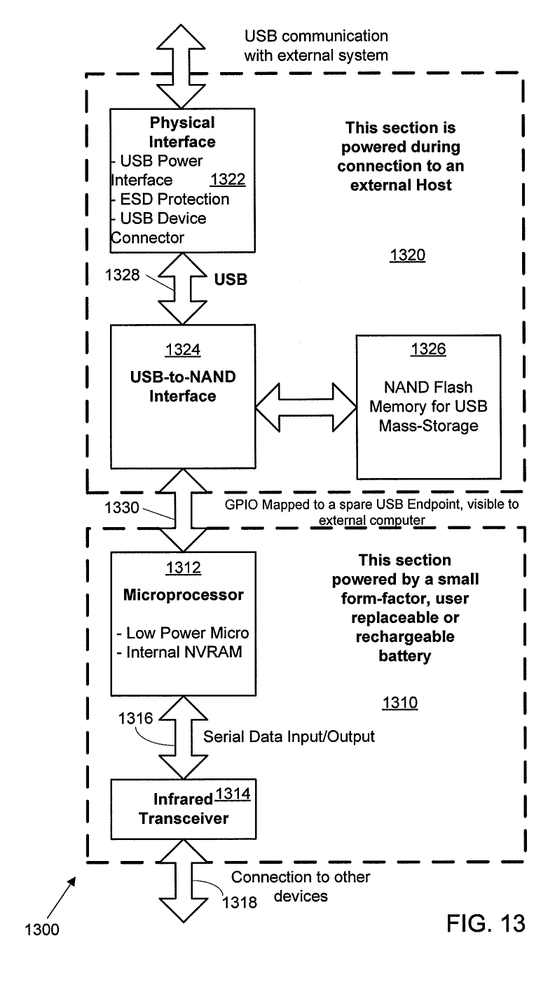

FIG. 12 is an exemplary schematic of circuitry 1200 of a product incentive distribution unit according to a possible embodiment of the present disclosure. The circuitry 1200 can reside, for example, within the product incentive distribution units of FIGS. 2-4, above, and which can be placed in association with products at a retail location. The circuitry 1200 generally receives product incentives from a variety of locations within a retail network, such as the network of FIG. 2. The product incentives can be received from a retailer (e.g. a retail inventory server) or from a supplier or manufacturer to the retailer. The circuitry 1200 includes a programmable circuit 1202, a communication interface 1204, network interface circuitry 1206, and nonvolatile memory 1208. The circuitry also optionally includes a power source 1210 and a display 1212.

The programmable circuit 1202 generally corresponds to the circuit 1102 of FIG. 11 in terms of physical components used in its implementation, but can be programmed with various different operational functionality. In the circuitry 1200, the programmable circuit generally accepts product information and product incentives via the network interface circuitry 1206 and distributes that information via the communication interface 1204 based on detection of a data communications device within range of that interface. The communication interface 1204 can be any of a variety of typically wireless interfaces (although a wired interface may be possible in certain embodiments) which transmit product incentive information in response to a request from a data communications device.

In certain embodiments, the communication interface 1204 is a targeted location on the product incentive distribution unit that receives (and optionally sends) data signals for exchange with a data communications device, using optical, wireless, or physical communication. For example, a photodiode-based sensor could be included in a translucent signal receipt portion of the incentive distribution unit and used to receive modulated laser signals transmitted optically from a data communications device having an optical interface, such as the infrared or laser-diode arrangement of the optical interface 1122 of FIG. 11, above. Other possibilities exist as well.

In use, the communication interface 1204 can receive a request for a product incentive from a data communications device, and can transmit data, as instructed by the programmable circuit and received from the nonvolatile memory 1208 to the data communications device in response to the request. The communication interface 1204 can communicate using a variety of types of communications links, such as an infrared link, a wireless radio frequency link, or other links as described in FIG. 5B, above.

In a further example of use, the communication interface 1204 can receive an identifier of a data communications device (e.g. the device identifier of FIG. 18, below), and communicate that identifier to a retail inventory server, such as the server 210 of FIG. 2. The retail inventory server can then associate that device identifier with a particular product incentive distributed from the product incentive distribution unit. When that product is scanned at a checkout system, the retail inventory database can be accessed and a product incentive can be applied if the customer possessing the device transmitted the device identifier to that product incentive distribution unit.

The network interface circuitry 1206 provides a data connection from the circuitry 1200 of the product incentive distribution unit to a network, such as the network 200 of FIG. 2. The network interface circuitry 1206 maintains a data connection with external systems or a retail inventory server to receive product incentives distributed to the unit by a retailer or distributor. The specific format of product incentives that are received may vary; however, in certain embodiments, the product incentives can be data messages that include the various data fields described in FIGS. 12-13, below.

The nonvolatile memory 1208 stores the product information, product incentives and optionally instructions for distributing the product incentives relating to the product incentive distribution unit. The nonvolatile memory 1208 is generally a low cost, low power memory, such as a flash memory, which can store information needed by the product incentive distribution unit. In certain embodiments, the nonvolatile memory can also include information uniquely identifying the product incentive distribution unit, such as a unique hardware address or identification code. Specific information stored in the unit may vary among the product incentive distribution units, based on the particular retailer, product, and location in which the unit is used. In certain embodiments, the unique identification code for the product incentive unit allows external systems managed by the retailer, manufacturer, or supplier that are communicatively connected to the unit to specifically target a unit with a particular product incentive. Additional information can be included in the nonvolatile memory as well.

The power source 1210 provides electrical power to the other circuitry 1200 where no external power source is supplied. The power source can be, for example, a rechargeable battery held within the housing of a product incentive distribution unit. The power source is interfaced to the programmable circuit 1202 and the network interface circuitry 1206, allowing it to receive power via the wired network interface 1206 and distribute that power via the programmable circuit to the other components of the circuitry 1200.

The display 1212 displays various product information to the user relating to the product with which the unit (and circuitry 1200) is associated, as well as incentives relating to the product. Example information displayed by the display is shown in FIGS. 3-4, above. The display can be any low-power, low cost display unit which provides high visibility to product details.

Although the circuitry 1200 is shown having certain components included, it is understood that additional components can be included as well. For example, the circuitry 1200 can include various audible devices configurable to emit sounds relating to initiation or completion of a transfer of a product incentive to a data communications device, or periodically to announce the existence of a product incentive that can be so transferred. Additionally, the circuitry 1200 can include instructions and functionality for receipt of device identifiers, for linking to product incentives at a checkout system (as seen in FIG. 2, above). Other arrangements are possible as well.

Now referring to FIGS. 13-15, various block diagrams of alternative internal circuitry for a data communications device. In these embodiments, the internal circuitry provides a generalized arrangement illustrating functionality of the device.

FIG. 13 is a schematic block diagram of portions of a data communications device 1300 according to a further possible embodiment of the present disclosure. The data communications device 1300 represents a further possible embodiment of the device previously described, and introduces certain additional features that can provide power savings for data communications.

Generally the communications device 1300 includes a powered region 1310 and an unpowered region 1320. The powered region 1310 is configured to operate in the absence of a connection to a personal computing device. The unpowered region 1320 includes circuitry components configured to operate only in the presence of a connection to a personal computing device. In the absence of a connection to an external personal computing device that can provide power to the unpowered region 1320, that region remains inactive and does not drain battery power from the powered region 1310.

The powered region 1310 includes a programmable circuit 1312 and a transceiver 1314, interconnected at a transceiver interface 1316. The programmable circuit 1312 provides data processing and controls data communications through the transceiver 1314. The programmable circuit 1312, shown as a microprocessor, includes a generally low power consumption and low capacity memory, such as an internal NVRAM memory. The memory in the programmable circuit 1312 can store certain firmware programs for controlling and configuring operation of the data communications device 1300, and can store user information, such as files or links to files, for access and review when the data communications device 1300 is connected to a computing device. The transceiver 1314 provides an interface for communication with other data communications devices. From the transceiver 1314, a wireless communication link 1318 can be established to another device, such as another data communications device 1300, using the communications media and protocols described herein. The transceiver interface 1316 can be any of a number of serial or parallel data interfaces capable of communicatively connecting the programmable circuit 1312 and transceiver 1314.

A power source (not shown) such as a battery or other portable power supply is provided and connected to the components of the powered region 1310. The power source provides electrical energy for operation of the items in the powered region 1310 when the device 1300 is not connected to a computing system. In certain embodiments, the power source can be user-replaceable, or rechargeable through a connection to a computing system (e.g. via the powered connection to the computing system included in the unpowered region 1320.

The unpowered region 1320 includes a physical interface 1322 interconnected to a memory interface 1324 and flash memory 1326. The physical interface 1322 provides data configuration and buffering necessary to communicate via a wired communications protocol (e.g. via a USB connection) with a computing system. The memory interface 1324 provides memory control and coordination of data transmission to both the flash memory 1326 and the programmable circuit 1312. The flash memory 1326 is generally a large-capacity memory configured to store files received either via the transceiver 1314 (e.g. wirelessly from another data communications device) or the physical interface 1322 (from a computing system).

The physical interface 1322 is connected to the memory interface 1324 by a powered link 1328, allowing distribution of power to the memory interface 1324 and the flash memory 1326. The powered region 1310 and unpowered region 1320 are connected by a general purpose input/output link 1330, which provides a data and electrical connection between the regions.

In general, the device 1300 is configured such that when the device is not connected to a computing system, the powered region 1310 can remain active to exchange files or links to files between devices. When the device is connected to a computing system, both the powered region 1310 and the unpowered region 1320 are active. In such an arrangement files are made accessible to the computing system that are stored both in the flash memory 1326 and the memory within the programmable circuit 1312.

Optionally, the programmable circuit 1312 can be configured to periodically transmit data from its internal memory (e.g. NVRAM) to the flash memory, preferably when the data communications device 1300 is connected to a computing system. In this way, the NVRAM of the programmable circuit can then be cleared, allowing additional storage of files or links to files in that limited memory space, and performing writes to flash memory 1326, which are relatively high-power-consumption operations, at a time when power is made available to the device 1300 from the computing system.

It can be seen that, through use of the separated powered and unpowered regions 1310, 1320, only a portion of the data communications device 1300 might be used when the device is not connected to a computing system to provide electrical power to the device. By including low power components for use in the powered region 1310 and higher-powered components in the unpowered region 1320, an extended battery life can be accomplished in the device 1300, by eliminating the power draw of large memories and controllers (e.g. the flash memory 1326 and controller 1324).

Although the data communications device 1300 is described as having certain components included, it is understood that additional components may be incorporated based on the choice of media by which the device communicates, the specific feedback mechanisms to be used by the device, and other features previously described.

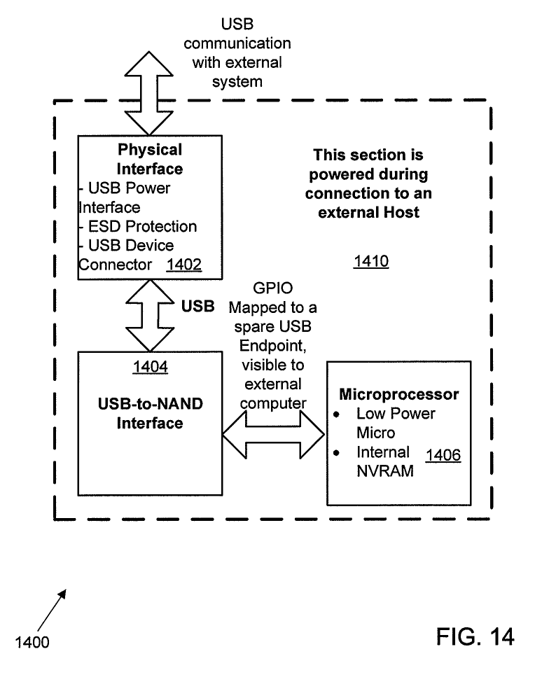

FIG. 14 illustrates a schematic block diagram of a portion of a data communications device 1400 according to a further possible embodiment of the present disclosure. In this embodiment, the data communications device 1400 generally corresponds to the device 1300 of FIG. 13; however, in the embodiment shown, only an unpowered region 1410 exists within the device. Therefore, the data communications device is only operable while in connection with an external computing system via a powered (e.g. USB) interface. As illustrated, the device 1400 includes a USB interface 1402, a USB-to-NAND interface 1404, and a programmable circuit 1406 which includes a memory. Each of these components provides analogous functionality to the like components of FIG. 13. In this embodiment, the data communications device 1400 operates analogously to a typical USB-flash drive device, but, rather than storing data in a flash memory, uses a link system (e.g. the link system described below in conjunction with FIGS. 27-31) to access files. The device 1400 therefore represents a cost-reduced version of the device 1300, which does not provide for direct device-to-device communication.

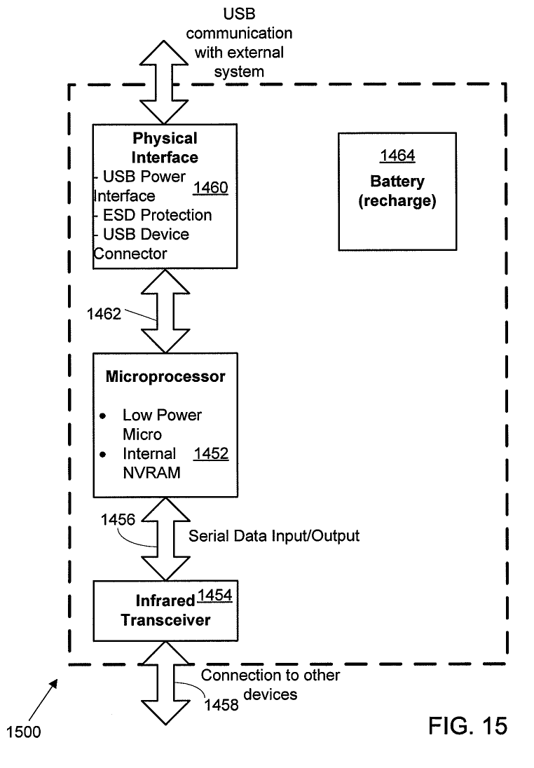

FIG. 15 illustrates a schematic block diagram of a portion of a data communications device 1500 according to a further possible embodiment of the present disclosure. In this embodiment, the data communications device 1450 generally corresponds to the device described in FIG. 13; however, device 1450 does not include a flash memory or related flash memory controller, thereby providing additional power and cost savings by managing links to files in a smaller-capacity, lower-power memory. The device 1450 includes a programmable circuit, illustrated as a microprocessor 1452, including the memory used by the device, such as an NVRAM. The programmable circuit 1452 is linked to a wireless transceiver 1454 by a serial connection 1456. The wireless transceiver 1454 allows the device 1450 to establish a wireless link 1458 to another device for file/link transfer. The programmable circuit 1456 is further connected to a USB interface 1460 via an electrical connection 1462. A battery 1464 provides power to the device when not connected to a computing system, and can, in various embodiments, be a rechargeable and/or user-replaceable battery.

Although the circuitry variants in FIGS. 13-15 are discussed in the context of use within a data communications device, analogous circuits can be implemented within the product incentive distribution units themselves, for wired or wireless data communications. It is noted that certain differences may exist in the circuitry depending upon the application to which it is directed (i.e. data communications device or product incentive distribution unit), such as can be seen in the differences between FIGS. 11 and 12.

FIGS. 16-18 show exemplary data packets that can be communicated using the methods and systems described herein. The data packets described in FIGS. 16-17 generally are communicated from suppliers or manufacturers to retailers (and on to product incentive distribution units), or from product incentive distribution units associated with products to data communications devices held by customers at a retail location. The example data packet of FIG. 18 generally can be sent from a data communications device to a product incentive distribution unit, and in turn to a retail inventory server and checkout system for application of a product incentive to an individual associated with the device.

FIG. 16 shows a first data packet 1600, which includes a number of start bits 1602, and a number of predetermined fields 1604a-c. The data packet 1600 corresponds to an electronic coupon or other electronic incentive (e.g. an advertisement or other message) provided by a manufacturer of a product. The start bits 1602 can represent bits used by the system to determine the size and/or structure of the data packet, and can otherwise include other “header” information regarding the data packet and data file as a whole (which may be split among one or more data packets). The predetermined fields 1604a-c are shown to include an identifier of a retailer 1604a, a date 1604b, a product identifier 1604c, and an amount 1604d respectively, representing the typical information provided in a product incentive, such as a coupon. Additional information can be included in the packet as well.

FIG. 17 shows a second data packet 1700 similar to the first data packet 1600 of FIG. 16. The data packet 1700 corresponds to an electronic coupon or other type of product incentive sponsored by the retailer. The data packet 1700 is generally similar to the packet 1600, but includes various alternate predetermined fields 1704a-e, including data identifying a manufacturer 1704a, a product 1704b, a discount 1704c, valid dates for the electronic coupon 1704d, and a retailer identifier 1704e.

FIG. 18 shows a third data packet 1800, which includes an identifier 1802 of a data communications device or user of such a device. The third data packet 1800 can be of various lengths, and, in one embodiment, is approximately 40 bits long (5 bytes). The identifier 1802 can be communicated from the data communications device to a product incentive distribution unit to associate that device with the specific product incentive at a retail inventory database, and can also be communicated from the data communications device to a checkout system to access and apply product incentives associated with the device.

The various data packets of FIGS. 16-18 can be used singly or in combination to communicate various data between a data communications device, a product incentive distribution unit, a retail inventory server, and a checkout system to coordinate and apply product incentives. Various processes by which this can be achieved are explained below.

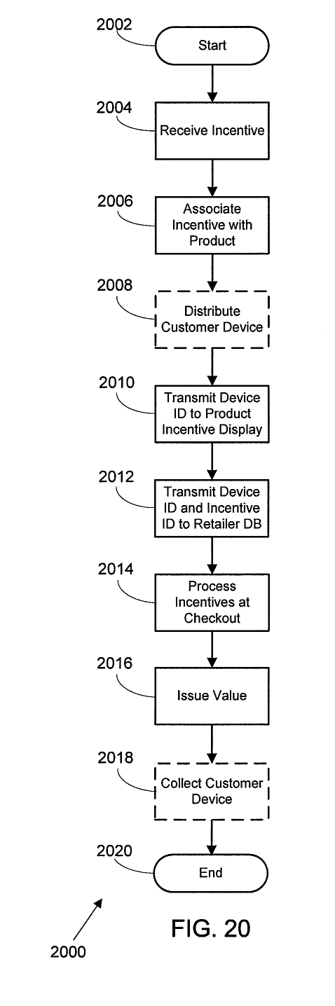

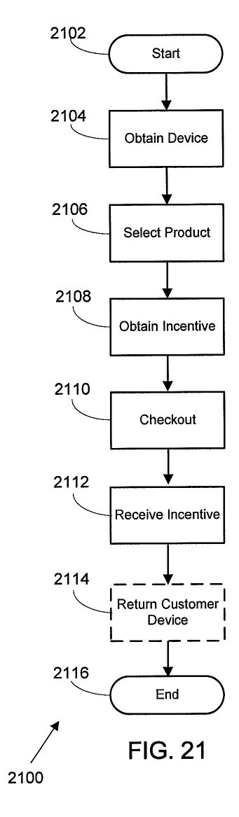

Now referring to FIGS. 19-21, methods and systems are disclosed for transmitting information throughout the communications networks disclosed herein, to provide product incentives to a retailer (e.g. from a supplier or manufacturer within the retailer's supply chain), and to distribute those product incentives for customers for use at a retail location. FIGS. 19 and 20 relate to distribution of product incentives using differing types of incentive distribution methodologies at a retail location, and FIG. 21 relates to acquisition and use of such incentives at alternative locations.

FIG. 19 illustrates a flowchart of methods and systems for distributing product incentives, according to a possible embodiment of the present disclosure. The flowchart illustrates a system 1900 that may be executed by a retailer at a point of sale, such as a retail store, in conjunction with that retailer selling goods to a consumer. The system 1900 is instantiated at a start operation 1902, which corresponds to initial setup of a product incentive distribution system according to the various embodiments of the present disclosure.

A receive incentive module 1904 corresponds to a retailer receiving one or more product incentives, such as from a manufacturer or supplier of goods that are sold by the retailer. In certain embodiments, the receive incentive module 1904 corresponds to creation of retailer-specific product incentives, such as in the case of retailer coupons or other in-store sales incentives. The receive incentives module 1904 can, in certain embodiments, correspond to a specific product incentive distribution unit receiving a product incentive via wired or wireless communication with a computing system managed by a manufacturer or supplier. In further embodiments, the receive incentives module 1904 corresponds to receipt of incentives at a retail inventory server, such as is shown in FIG. 2, as well as subsequent distribution of those incentives to one or more product incentive distribution units in use throughout the retail location.

An incentive association module 1906 corresponds to the retailer associating the incentives received by the retailer with the products to which the incentives are targeted. The incentive association module 1906 can include, for example, communicating product incentives to one or more product incentive distribution units that are previously associated with products to which the incentives are targeted. The incentive association module 1906 can use a table of product incentive distribution unit identifiers, such as a table stored in a product inventory server (e.g. the server 210 of FIG. 2) to target specific product incentive distribution units and distribute only incentives relating to that product and unit to the appropriate unit. In certain additional embodiments, the incentive association module 1906 also includes distributing product incentive distribution units to locations associated with the products.

In embodiments in which a retailer does not implement a retail inventory server, the incentive association module 1906 and incentive distribution module 1904 can be said to execute concurrently, in that the incentives are distributed directly to product incentive distribution units that are previously associated with the specific products. This direct distribution of product incentives can occur from manufacturers, suppliers or a system external to the retailer, and can be accomplished through any of the various types of wired or wireless data communication accommodated by the product incentive distribution units, as previously described.

A distribution module 1908 corresponds to distributing one or more data communications devices to customers at the retail location. The distribution module 1908 can include selling the data communications devices (for a nominal cost) to customers, or lending devices to customers. Generally, the devices are handheld data communications devices which can receive product incentives, preferably wirelessly, from the product incentive distribution units distributed among the shelves and other displays at the retail location. In certain embodiments, the data communication devices correspond to the devices described above in conjunction with FIGS. 5-10, and can receive data packets relating to product incentives, such as those shown in FIGS. 16-17.

In embodiments of the system 1900 using a kiosk for distribution (e.g. kiosk 212 of FIG. 2), the distribution module 1908 corresponds to distribution of a device and optionally programming the device with identifying information (e.g. a device identifier), as well as advertising one or more specific product incentives that the retailer wishes to communicate to a user who may not view those incentives during their visit to the retail location.

A transmission module 1910 transmits (generally wirelessly) a product incentive from one of the product incentive distribution units at the retail location to at least one data communications device held by a customer. In certain embodiments, the transmission module 1910 can be triggered by a request from the data communications device held by the customer, such as by the customer pressing a button on the data communications device. In response to receiving the request, the product incentive distribution unit can transmit a data packet to the data communications device for storage thereon.

A customer shopping at a retail location may cause operation of the transmission module 1910 many times relating to different products at a retail location. For example, the customer can select many products for purchase, and can trigger transmission of a product incentive relating to each product. Each of the different product incentives can be stored on the data communications device, so that when the customer has completed selecting products and requesting product incentives throughout the retail location, that customer has stored on the data communications device a number of product incentives relating to the products that customer plans to purchase.

A processing module 1912 corresponds to processing the incentives collected by a customer during a shopping trip to a retail location. The processing module is generally performed using the data communications device used by the customer to collect the product incentives, as well as a checkout system, such as shown in FIG. 2. The processing module 1912 operates in conjunction with the checkout system to charge the customer an appropriate amount for the goods purchased, and corresponds to collection of the product incentives collected in the memory of the data communication device in a checkout system, and cross referencing those incentives with the products purchased (e.g. scanned using a bar code scanner at the checkout system) to ensure that all incentives are applied that should be (and that no incentives are applied where corresponding products are not purchased).

Optionally, the processing module 1912 corresponds to deletion of the various product incentive data stored in the data communications device, thereby preventing reuse of the product incentive. In further embodiments, the product incentives include data relating to an expiration date (see, e.g., FIG. 17) and may be used more than once by a customer.

An incentive issuance module 1914 issues an incentive to the customer relating to the properly processed product incentives as determined by the processing module 1912. The incentive issuance module 1914 can correspond, in certain embodiments, to issuance of a gift card redeemable at the retailer, thereby encouraging the customer to return to the retailer for a subsequent shopping trip. The gift card can include credit for the value of the incentives collected which correspond to products purchased by the user.

In other embodiments, the monetary value of the incentives is used to reduce the amount which the customer is charged for the concurrently-purchased goods (as coupons are typically applied). Other incentives (prizes, cash back, etc) can be used as well.

A device collection module 1916 can optionally correspond to the customer returning the data communications device to the retailer for use by another customer. The device collection module 1916 generally corresponds to erasing the incentives stored on the device and otherwise preparing the device for a subsequent use.

In embodiments where no device collection module 1916 is implemented, the customer may choose to keep the data communications device for subsequent shopping trips, or may choose to discard the device. In instances where the customer chooses to keep the device, preferably the product incentives stored in the memory of the device include an indication of an expiration date or have a used/unused flag which indicates whether the customer has already received the product incentive during a previous shopping trip.

The system 1900 terminates at an end operation 1918, which corresponds with completion of a shopping experience by the customer at the retail location.

The various modules of the system 1900 generally can be rearranged in a variety of orders, such that no particular order is ascribed to the modules 1902-1916 of FIG. 19. For example, the device collection module 1916 could occur prior to the processing module, and corresponds to the customer handing a data communications device to a cashier for use in processing the product incentives stored thereon. Other arrangements of modules and other orders of operation can be utilized as well.

FIG. 20 illustrates a flowchart of methods and systems for distribution of product incentives according to a further possible embodiment of the present disclosure. The flowchart illustrates a system 2000 that may be executed by a retailer at a point of sale, such as a retail store, in conjunction with that retailer selling goods to a consumer. The system 2000 is instantiated at a start operation 2002, which corresponds to initial setup of a product incentive distribution system according to the various embodiments of the present disclosure.

In the embodiment shown, a receive incentive module 2004, an incentive association module 2006, and a device distribution module 2008 generally correspond to the analogous operations (1904, 1906, and 1908, respectively) as described in FIG. 19, above. However, rather than a transmission module 1910 causing data to be transmitted from an incentive distribution unit to a data communications device for storage and use, the system 2000 instead includes a device transmission module 2010 which transmits an identifier of the data communications device to the incentive distribution unit. The identifier represents a specific identifier unique to the data communications device, such as a data packet as illustrated in FIG. 18, above. A server transmission module 2012 corresponds to transmission of the device identifier to a retail inventory server (e.g. the server 210 of FIG. 2) for association with a product incentive stored at that server.

A processing module 2014 processes incentives “collected” by the data communications device at a checkout system, when the customer intends to pay for his/her items. In this embodiment, the processing module 2014 corresponds to accessing the retail inventory server to determine which incentives are associated with a data communications device (i.e. by operations 2010 and 2012), by reviewing stored data on the server and corresponding that data to scanned items at the checkout system. In this way, the customer can receive incentives, if any, for items that the customer selected for purchase and intended to collect incentives. The processing module 2014 can be performed at the checkout system by obtaining the device identifier from the data communications device, or by scanning a bar code linked to the device identifier which is printed on the data communications device. Other possibilities exist as well.

An incentive issuance module 2016, and an optional device collection module 2018, correspond to like modules (1914 and 1916, respectively) of FIG. 19, above. Likewise, an end operation 2020 corresponds with completion of a shopping experience by the customer at the retail location.

Optionally, in the system 2000, the device identifiers in the retail inventory server can be cleared daily or otherwise periodically to ensure that stale incentives are not retained and used by the device. Other timing arrangements could be used as well, depending upon the type and size of retail location in which the system is used, as well as the expected frequency of customer visits and incentive changes.

FIG. 21 illustrates a flowchart of methods and systems for use of product incentives, according to a possible embodiment of the present disclosure. The system 2100 shown generally corresponds to customer-performed steps in the use of a product incentive distribution system, according to certain embodiments of the present disclosure. The system 2100 is instantiated at a start operation 2102, which corresponds to an initial visit to a retail location by a customer. Operational flow proceeds to an obtain device module 2104, which generally corresponds to the customer receiving a data communications device, such as one of the handheld devices useable to collect product incentives, as described above in conjunction with FIGS. 5-10.

A product selection module 2106 corresponds to the customer shopping at the retail location, and selecting products for purchase. An incentive acquisition module 2108 corresponds to the customer obtaining product incentives using the data communications device, such as by initiating transfer of a data packet including a product incentive from a product incentive distribution unit (see, e.g., FIGS. 2-4) to the data communications device. The customer may choose to select more than one product and corresponding product incentive, with the product incentives accumulating in the memory of the data communications device. The product incentives correspond to the product selected via the product selection module 2106.

In certain embodiments, the incentive acquisition module 2108 can occur at a time other than when the customer is at a retail location. For example, the incentive acquisition module 2108 can correspond to the customer viewing a product incentive on a home computer or at some other location, and downloading that product incentive to the data communications device. In such embodiments, the data communications device can utilize a communications port or some other electrical interface, such as a USB interface (as described in FIG. 10, above) to acquire product incentives.

Operational flow proceeds to a checkout module 2110, which corresponds to the customer completing his/her shopping and checking out at one or more checkout systems. The checkout system (and optionally the cashier) performs a checkout operation, such as described in conjunction with the processing module 2112 and incentive issuance module 1914 of FIG. 19, above. The customer receives an incentive at an incentive receipt module 2112, which can correspond to receipt of a gift card, prize, reduced price of the goods, cash back, or other product incentive.

During operation of the checkout module, the incentive received can have any of a number of terms associated with it, such that the customer can apply that incentive to either the current purchase or to future purchases from the same retailer, supplier, or distributor. For example, the incentive can correspond to a discount for goods or services selected by the customer. In such a situation, the discount can be applied before an overall cost is charged to the customer, resulting in a discounted cost charged to the customer which is less than the overall cost. In other situations, terms for applying the incentive can require that the incentive be applied to discount the cost of subsequent purchases from the same retailer, supplier, or manufacturer. In further situations, the discount can be applied only against future purchases of the same product to which the collected incentive(s) relates.

An optional return module 2114 corresponds to the customer returning the data communications device to the retail location. Operational flow within the system terminates at an end operation 2116, which corresponds to completion of a shopping trip to a retail location by a customer.

In alternative embodiments to the system 2100, an analogous operation to that illustrated in FIG. 20 may be possible outside the context of a retail location, such that a customer having a data communications device can shop on the internet and collect product incentives by transmitting a device identifier to a selected retailer operating a retail inventory server as previously described.

As with FIGS. 19-20, the modules of the system 2100 can be rearranged in various orders based on the particular implementation of that system. No particular order is ascribed to the modules based on the ordering of their discussion herein.

Now referring to FIGS. 1-21 generally, it is understood that certain additional features and functionality can be included within the systems and methods described. For example, a retail location can periodically associate device identifiers with a particular incentive, thereby providing promotional retailer credit toward purchasers by targeted customers. Therefore, a targeted customer loyalty program can be administered using the data communications device, but could be based upon a retailer, supplier, or even a manufacturer (as opposed to existing retailer-specific loyalty programs).

In general, it is understood that using the methods and systems of the present disclosure any number of customers can visit any number of retail locations and receive product incentives distributed by that source, retailer, or retail location for use. Furthermore, a variety of types of product incentives can be distributed directly from a manufacturer or retailer to a customer in a short timeframe (e.g. by avoiding print circulation time delays and cost).

The above specification, examples and data provide a complete description of the manufacture and use of the composition of the invention. Since many embodiments of the invention can be made without departing from the spirit and scope of the invention, the invention resides in the claims hereinafter appended.

1. A product incentive distribution system comprising:
a product incentive distribution unit placed at a retail location in association with a product and configured to electronically receive product incentives, the product incentive distribution unit including:
a display configured to display product information and product incentive information; and
a communication port configured to transmit product incentive information to a data communications device;
a handheld data communications device including:
a communication port configured to receive product incentive information; and
a memory configured to collect product incentive information; and
a checkout system including a communications interface communicatively connectable to the data communications device, the checkout system configured to receive product incentive information from the handheld data communications device and apply the product incentive information to one or more products purchased by a user.

2. The product incentive distribution system of claim 1, wherein the checkout system is further configured to distribute a gift card containing store credit corresponding to at least a portion of the product incentive information.

3. The product incentive distribution system of claim 1, wherein the checkout system is further configured to, by applying the product incentive information to the one or more products, apply a discount to an overall cost of products purchased by the user.

4. The product incentive distribution system of claim 1, wherein the product incentive distribution unit is configured to electronically receive product incentives from a supplier of a product associated with the product incentive distribution unit.

5. The product incentive distribution system of claim 1, wherein the discount is applied before the customer is charged, thereby charging the customer a cost less than the overall cost.

6. The product incentive distribution system of claim 1, further comprising a plurality of product incentive distribution units associated with a corresponding plurality of products.

7. The product incentive distribution system of claim 1, further comprising a retail inventory server configured to receive the product incentive information from a supplier and distribute the product incentive information to the product incentive distribution unit.

8. The product incentive distribution system of claim 1, wherein the product incentive information relates to at least one of:
product incentives provided by the retailer,
product incentives provided by a supplier of a product associated with the product incentive information, or
product incentives provided by a manufacturer of a product associated with the product incentive information.

9. A method of distributing product incentives to in-store customers, the method comprising:
distributing a product incentive distribution unit in association with a product at a retail location;
receiving a product incentive at the product incentive distribution unit, the product incentive being transmitted from a source of the product;
displaying information relating to the product incentive on a display of the product incentive distribution unit;
transmitting the product incentive to a handheld data communications device associated with a customer; and
processing the product incentive by a checkout system.

10. The method of claim 9, further comprising distributing the data communications device to the customer.

11. The method of claim 9, wherein transmitting the product incentive to a data communications device associated with the customer includes wirelessly transmitting the product incentive in response to a request from the data communications device.

12. The method of claim 9, further comprising deleting the product incentive from the data communications device

13. The method of claim 9, further comprising distributing the data communications device to a customer.

14. The method of claim 9, wherein the data communications device communicates using an interface selected from the group consisting of:
a wired communication interface;
a USB communication interface;
an infrared communication interface;
an optical laser interface;
a radio frequency communication interface; and
an audible communication interface.

15. The method of claim 9, wherein processing the product incentive by a checkout system includes issuing a gift card including a value of the product incentive.

16. The method of claim 9, wherein processing the product incentive by a checkout system includes crediting the customer by a value associated with the product incentive.

17. The method of claim 9, wherein the source of the product is selected from the group consisting of:
a manufacturer of the product;
a supplier of the product; and
a retailer of the product.

18. A product incentive distribution system comprising:
a product incentive distribution unit placed in association with a product, the product incentive distribution unit including:
a display configured to display product information and product incentive information; and
a communication port configured to communicate with a data communications device;
a handheld data communications device including:
a communication port configured to communicate with the product incentive distribution unit; and
a memory configured to store information related to the product incentive distribution system, the information including a device identifier;
a checkout system configured to:
process a retail transaction with a customer associated with the handheld data communications device; and
receive product incentive information and apply the product incentive information to one or more products purchased by the customer; and
a retail inventory server configured to electronically receive product incentive information from a source of a product and associate the handheld data communications device with one or more of the product incentives based on the device identifier, the device identifier received from the product incentive distribution unit.

19. The system of claim 18, wherein the data communications device is a handheld USB memory device.

20. The system of claim 18, wherein the source of the product is selected from the group consisting of:
a manufacturer of the product;
a supplier of the product; and
a retailer of the product.

21. The system of claim 18, wherein the checkout system is configured to identify the data communications device based on a device identifier.

22. The system of claim 21, wherein the device identifier is associated with a code printed on the data communications device.

23. The system of claim 18, further comprising a kiosk arranged at a retail location and configured to distribute the handheld data communications device to the customer.

24. The system of claim 23, wherein the kiosk is further configured to associate the customer with a customer rewards account managed at the retail inventory server.

25. A method of distributing product incentives to in-store customers, the method comprising:
distributing a product incentive distribution unit in association with a product at a retail location;
receiving a product incentive at a retail inventory server, the product incentive being transmitted from a source of the product;
displaying information relating to the product incentive on a display of the product incentive distribution unit;
obtaining an identifier of a handheld data communications device associated with a customer at the product incentive distribution unit;
transmitting the identifier to the retail inventory server for association with the product incentive; and
processing the product incentive by a checkout system.

26. The method of claim 25, further comprising distributing a data communications device to a user from a kiosk at the retail location.

27. The method of claim 25, wherein obtaining the identifier includes receipt of a transmitted identifier at the product incentive distribution unit using an interface selected from the group consisting of:
a wired communication interface;
a USB communication interface;
an infrared communication interface;
an optical laser interface;
a radio frequency communication interface; and
an audible communication interface.
